(19) United States
(12) Patent Application Publication
(10) Pub. No.: US 2020/0190267 A1
(43) Pub. Date: Jun. 18, 2020

(54) PROCESS FOR PREPARING A POLYOLEFIN COMPOSITION

(71) Applicant: Basell Polyolefine GmbH, Vesseling (DE)

(72) Inventors: Decio Malucelli, Ferrara (IT); Marco Consalvi, Ferrara (IT); Gerhardus Meier, Houston, TX (US); Ulf Schueller, Weiterstadt (DE)

(73) Assignee: Basell Polyolefine GmbH, Wesseling (DE)

(21) Appl. No.: 16/641,552

(22) PCT Filed: Aug. 30, 2018
(86) PCT No.: PCT/EP2018/073359

§ 371 Date: Feb. 24, 2020

(30) Foreign Application Priority Data
Sep. 1, 2017 (EP) 17189027.0

(51) Int. Cl. C08J 3/20; C08F 10/02; C08K 5/00; B29B 7/00; B29B 9/06; B29B 7/16; B29B 7/42; B29B 7/60; B29B 7/88

(52) U.S. Cl. CPC C08J 3/203; C08F 10/02; C08K 5/00; B29B 7/007; B29B 9/06; B29K 2105/0044; B29B 7/42; B29B 7/60; B29B 7/88; C08J 2323/06; B29K 2023/06; B29B 7/16

(57) ABSTRACT

A process for preparing a polyolefin composition including the steps of supplying a bimodal or multimodal polyolefin in form of a polyolefin powder having an mass-median-diameter D50 in the range from 300 μm to 2500 μm and one or more additives to a mixing device, mixing the polyolefin powder and the additives at a temperature from 10° C. to 120° C., transferring the mixture into a extruder device, melting and homogenizing the mixture within the extruder device to form a molten polyolefin composition, and pelletizing the molten polyolefin composition.

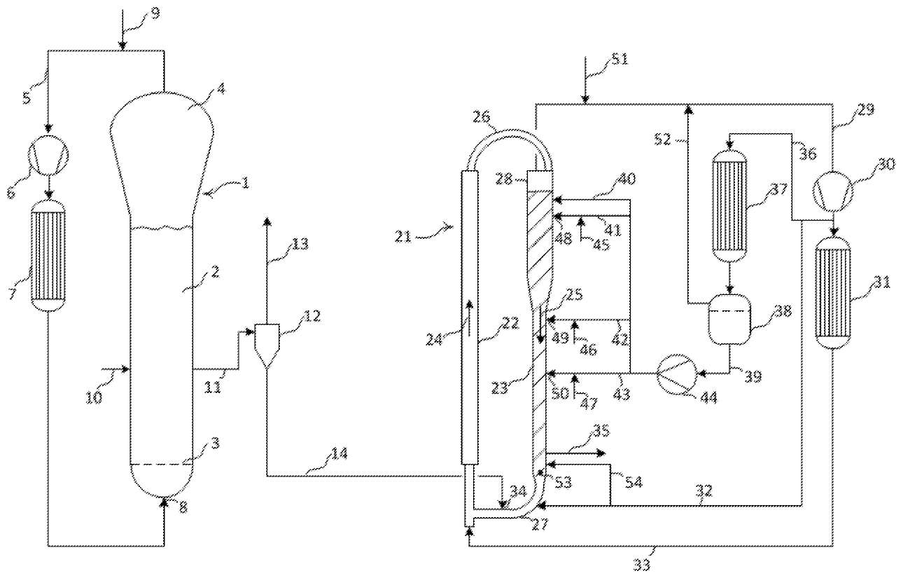

### FIELD OF THE INVENTION

In general, the present disclosure relates to the field of chemistry. More specifically, the present disclosure relates to polymer chemistry. In particular, the present disclosure provides a process for continuously preparing a polyolefin composition made from or containing bimodal or multimodal polyolefin.

### BACKGROUND OF THE INVENTION

For some applications, polyolefins are equipped with additional substances. These plastics additives influence the properties of the polymers although the additives are added in small quantities. In some instances, additives are combined with the polyolefins directly after their polymerization during the pelletizing step.

In some instances, bimodal or multimodal polyolefins are prepared in a cascade of two or more polymerization reactors having different polymerization conditions. In some instances, individual particles of the polyolefin powder obtained in such polymerization processes vary strongly in their composition. In those instances, these polyolefins are homogenized in the pelletizing step.

Gas-phase olefin polymerization processes permit a wide range of different olefins to be used as comonomers. However, to ensure a good operability of the polymerization process, relatively coarse catalyst particle are employed, resulting in polymer powders of particles having quite large diameters. In case of producing bimodal or multimodal polyolefins, these relatively large polymer particles increase the issue of achieving a good homogeneity in the final polymer product. The homogeneity of the material raises issues for polymers used for preparing films or extruding pipes because the non-homogeneous material may result in gels.

### SUMMARY OF THE INVENTION

In general, the present disclosure provides a process for preparing a polyolefin composition made from or containing bimodal or multimodal polyolefin in an extruder device including the steps of:
a) supplying a bimodal or multimodal polyolefin in form of a polyolefin powder having a mass-median-diameter D50 of the polyolefin particles in the range from 300 μm to 2500 μm to a mixing device;
b) supplying one or more additives to the mixing device;
c) mixing the polyolefin powder and the additives at a temperature in the range from 10° C. to 120° C. without melting the polyolefin powder to form a mixture;
d) transferring the mixture of polyolefin powder and additives from the mixing device into the extruder device;
e) melting and homogenizing the mixture of polyolefin powder and additives within the extruder device to form a molten polyolefin composition; and
f) pelletizing the molten polyolefin composition,
   wherein one of the additives is an organic peroxide.

In some embodiments, the mass-median-diameter D50 of the polyolefin particles is in the range from 400 μm to 2500 μm.

In some embodiments, the organic peroxide is selected from the group consisting of 2,5-dimethyl-2,5-di(tert-butylperoxy)hexane, 3,6,9-triethyl-3,6,9-trimethyl-1,2,4,5,7,8-hexoxonane, and representatives of 3,6,9-trimethyl-3,6,9-tris(alkyl)-1,2,4,5,7,8-hexoxonanes wherein the alkyl radical is propyl or ethyl.

In some embodiments, the organic peroxide is added in form of a mixture of the organic peroxide with a polyolefin powder.

In some embodiments, the polymerization for preparing the bimodal or multimodal polyolefin is carried out in the presence of a polymerization catalyst which is a Ziegler- or Ziegler-Natta-catalyst made from or containing the reaction product of an aluminum alkyl with a titanium compound supported on a magnesium halide.

In some embodiments, the mixing device is a paddle mixer having one or two horizontally orientated rotating shafts.

In some embodiments, the polyolefin powder is transferred from the mixing device to the extruder device by gravity.

In some embodiments, the polyolefin powder has been prepared in one or more gas-phase polymerization reactors.

In some embodiments, at least one of the gas-phase polymerization reactors is a multizone circulating reactor wherein a polymerization zone is a riser, wherein growing polymer particles flow upwards under fast fluidization or transport conditions, and the other polymerization zones are sub-zones of a downcomer, wherein the growing polymer particles flow downward in a densified form, wherein the riser and the downcomer are interconnected and polymer particles leaving the riser enter the downcomer and polymer particles leaving the downcomer enter the riser, thereby establishing a circulation of polymer particles through the riser and the downcomer.

In some embodiments, the polyolefin powder is obtained by polymerizing one or more 1-olefins in a cascade of at least two polymerization reactors.

In some embodiments, the polyolefin is a polyethylene.

In some embodiments, the polyethylene is a high density polyethylene having a density determined according to ISO 1183 at 23° C. from 0.945 to 965 g/cm³.

In some embodiments, the extruder device is a continuous mixer with counter rotating twin rotors or the extruder device having at least one co-rotating twin screw extruder.

### BRIEF DESCRIPTION OF THE DRAWINGS

The FIGURE shows schematically a reactor set-up for preparing bimodal or multimodal polyolefins.

### DETAILED DESCRIPTION OF THE INVENTION

In some embodiments, the present disclosure provides a process for preparing a polyolefin composition made from or containing bimodal or multimodal polyolefin and one or more additives. In some embodiments, the polyolefins are obtained by polymerizing olefins, alternatively 1-olefins, that is, hydrocarbons having terminal double bonds, without being restricted thereto. In some embodiments, the olefins are nonpolar olefinic compounds, including aryl-substituted 1-olefins. In some embodiments, the olefins are linear C₂-C₁₂-1-alkenes, branched C₂-C₁₂-1-alkenes, conjugated and nonconjugated dienes, or mixtures of various 1-olefins. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched C₂-C₁₀-1-alkene is 4-methyl-1-pentene. In some embodiments, the dienes are selected from the group consisting of 1,3-butadiene, 1,4-hexadiene and 1,7-octadiene. In some embodiments, the olefins have the double bond as part of a cyclic structure. In some embodiments, the olefins have one or more ring systems. In some embodiments, the cyclic olefins are selected from the group consisting of cyclopentene, norbornene, tetracyclododecene and methylnorbornene. In some embodiments, the cyclic olefins are dienes selected from the group consisting of 5-ethylidene-2-norbornene, norbornadiene and ethylnorbornadiene.

In some embodiments, the process is for preparing polyolefin compositions made from or containing any kind of polyolefin, alternatively obtained by homopolymerization or copolymerization of ethylene or propylene. In some embodiments, the comonomers in propylene polymerization are up to 40 wt. % of ethylene, 1-butene or 1-hexene, alternatively from 0.5 wt. % to 35 wt. % of ethylene, 1-butene or 1-hexene.

In some embodiments, the process is for preparing a polyolefin composition made from or containing polyolefins obtained by homopolymerizing or copolymerizing ethylene. In some embodiments, the comonomers in ethylene polymerization are up to 40 wt. % of C₃-C₈-1-alkenes. In some embodiments, the C₃-C₈-1-alkenes are selected from the group consisting of 1-butene, 1-pentene, 1-hexene, 1-octene, and mixtures thereof. In some embodiments, the ethylene is copolymerized with from 0.01 wt. % to 20 wt. %, alternatively from 0.05 wt. % to 12 wt. %, of one or more C₃-C₈-1-alkenes. In some embodiments, the comonomers for the copolymerization of ethylene are selected from the group consisting of 1-hexene and 1-butene.

In some embodiments, the polyolefins are bimodal or multimodal polyolefins. As used herein, the terms “bimodal” and “multimodal” refer to the modality of the molecular weight distribution. In some embodiments, the polymers are obtained from polymerizing olefins in a cascade of two or more polymerization reactors under different reaction conditions or by employing mixed catalyst system made from or containing two or more types of polymerization catalysts which produce, under the same polymerization conditions, polyolefins of a different molecular weight. As used herein, the “modality” indicates how many different polymerization conditions were utilized in preparing the polyolefin. In some embodiments, this modality of the molecular weight distribution is recognized as separated maxima in a gel permeation chromatography (GPC) curve. In some embodiments, this modality of the molecular weight distribution is not recognized as separated maxima in a gel permeation chromatography (GPC) curve. In some embodiments, this modality is determined by the number of different types of polymerization catalysts in a mixed polymerization catalyst system. In some embodiments and as used herein, the term “multimodal” includes bimodal. In some embodiments and in addition to the molecular weight distribution, the polyolefin polymer has a comonomer distribution. In some embodiments, the comonomer distribution is such that the average comonomer content of polymer chains with a higher molecular weight is higher than the average comonomer content of polymer chains with a lower molecular weight. In some embodiments, identical or very similar reaction conditions are employed in the polymerization reactors of the reactor cascade, thereby yielding narrow molecular weight polyolefin polymers. It is believed that in some embodiments, a cascade of polymerization reactors operating at different reaction conditions presents different residence times for individual polyolefin particles in different reactors and varies the composition of the individual polyolefin particles.

In some embodiments, the polymerization methods are selected from the group consisting of solution processes, suspension processes, and gas-phase processes. In some embodiments, the polymerization is carried out batchwise or continuously in two or more stages. In some embodiments, the polymerization method is gas-phase polymerization or suspension polymerization. In some embodiments, the gas-phase polymerization uses gas-phase fluidized-bed reactors or multi-zone circulating gas-phase reactors. In some embodiments, the suspension polymerization uses loop reactors or stirred tank reactors.

In some embodiments, the polyolefin composition is made from or contains bimodal or multimodal polyolefins prepared in gas-phase polymerization. In some embodiments, the bimodal or multimodal polyolefins are prepared in a multi-zone circulating gas-phase reactor. In some embodiments, the bimodal or multimodal polyolefins are prepared in a reactor cascade of two or more gas-phase polymerization reactors, alternatively a reactor cascade of two or more fluidized-bed reactors, alternatively a reactor cascade including a multi-zone circulating gas-phase reactor and one or more different gas-phase polymerization reactors, alternatively a cascade of first one or more suspension polymerization reactors and subsequently one or more gas-phase polymerization reactors. In some embodiments, the gas-phase polymerization reactors are fluidized-bed reactors. In some embodiments, the suspension polymerization reactors are loop reactors.

In some embodiments, the apparatus for preparing the bimodal or multimodal polyolefins includes a gas-phase polymerization reactor which includes a riser unit, wherein growing polymer particles flow upwards under fluidization, fast fluidization or transport conditions, and a downcomer, wherein the growing polymer particles flow downward in a densified form.

In some embodiments, the riser unit, wherein the growing polymer particles flow upwards, includes a fluidized bed of growing polymer particles. The riser unit then operates as thoroughly mixed gas-phase reactor such as a fluidized bed reactor. Fluidized-bed reactors are reactors in which the polymerization takes place in a bed of polymer particles which is maintained in a fluidized state by feeding in a reaction gas mixture at the lower end of a reactor and taking off the gas again at the reactor's upper end. In some embodiments, the reaction gas mixture is fed below a gas distribution grid having the function of dispensing the gas flow. The reaction gas mixture is then returned to the lower end to the reactor via a recycle line equipped with a compressor and a heat exchanger for removing the heat of polymerization. The velocity of the reaction gas mixture fluidizes the mixed bed of finely divided polymer present in the tube serving as polymerization zone and removes the heat of polymerization.

In some embodiments, a polymerization unit including a fluidized bed of growing polymer particles is employed as the riser unit while the downcomer is positioned within, around or adjacent to the gas-phase reactor. In some embodiments, two or more separated polymerization units are used as the downcomer, wherein the growing polymer particles flow downward in a densified form.

In some embodiments, the riser unit is a riser, wherein an upward movement of growing polymer particles occurs under fast fluidization or transport conditions. Fast fluidization conditions inside the riser are established by feeding a reaction gas mixture at a velocity higher than the transport velocity of the polymer particles. In some embodiments, the velocity of the reaction gas mixture is between 0.5 and 15 m/s, alternatively between 0.8 and 5 m/s. As used herein, the terms “transport velocity” and “fast fluidization conditions” are as defined in “D. Geldart, Gas Fluidization Technology, page 155 et seq., J. Wiley & Sons Ltd., 1986”.

The part of the polymerization reactor wherein the growing polymer particles flow downward in a densified form is referred to herein as a “downcomer”, a “moving bed”, or a “settled bed” unit. As used herein, the term “densified form” refers to the ratio between the mass of polymer and the reactor volume being higher than 80% of the “poured bulk density” of the resulting polymer. As such, a polymer bulk density equal to 420 kg/m³ implies a “densified form” or a polymer mass/reactor volume ratio of at least 336 kg/m³. In some instances, “poured bulk density” is measured according to DIN EN ISO 60: 1999. The density of solid inside the reactor is defined as the mass of polymer per volume of reactor occupied by the polymer.

In some embodiments, a downcomer is a part of the polymerization reactor containing a bed of growing polymer particles, which moves downwards in a plug flow mode. As used herein, the term “plug flow mode” refers to the absence of backmixing of the polymer particles.

In some embodiments and for replacing reacted olefins and controlling the gas flow within the downcomer, gaseous or liquid feed streams are introduced at one or more positions into the downcomer. In some embodiments, the feed streams are made from or contain ethylene. In some embodiments, the feed streams are further made from or contain one or more comonomers, inert components, or hydrogen. In some embodiments, the inert component is propane. In some embodiments and depending on the amounts of added gaseous or liquid feed streams to the downcomer and the pressure conditions within the downcomer, the gaseous medium surrounding the polymer particles moves downwards concurrently with the polymer particles or upward countercurrently to the polymer particles. In some embodiments, liquid streams are fed to and vaporize within the downcomer, thereby contributing to the composition of the reaction gas mixture within the downcomer. In some embodiments, the downcomer is operated with more than one feed stream being fed at different points. In some embodiments, the feeding points are evenly distributed over the height of the downcomer.

In some embodiments, the gas-phase polymerization reactor is a multizone circulating reactor. In some embodiments, the gas-phase polymerization reactors are as described in Patent Cooperation Treaty Publication Nos. WO 97/04015 A1 and WO 00/02929 A1 and have two interconnected polymerization zones, a riser, wherein the growing polymer particles flow upward under fast fluidization or transport conditions and a downcomer, wherein the growing polymer particles flow in a densified form under the action of gravity. The polymer particles leaving the riser enter the downcomer and the polymer particles leaving the downcomer are reintroduced into the riser, thereby establishing a circulation of polymer between the two polymerization zones and the polymer is passed alternately a plurality of times through these two zones. In such polymerization reactors, a solid/gas separator is arranged above the downcomer to separate the polyolefin and reaction gaseous mixture coming from the riser. The growing polyolefin particles enter the downcomer and the separated reaction gas mixture of the riser is continuously recycled through a gas recycle line to one or more points of reintroduction into the polymerization reactor. In some embodiments, the major part of the recycle gas is recycled to the bottom of the riser. In some embodiments, the recycle line is equipped with a compressor and a heat exchanger for removing the heat of polymerization. In some embodiments, a line for the catalyst feed is arranged on the riser and a polymer discharge system is located in the bottom portion of the downcomer. In some embodiments, the introduction of make-up monomers, comonomers, hydrogen, or inert components occurs at various points along the riser and the downcomer.

In some embodiments, the reaction gas mixture leaving the riser unit is partially or totally prevented from entering the downcomer for establishing different polymerization conditions between the riser unit and at least a part of the downcomer. In some embodiments, a barrier fluid in form of a gas or liquid mixture into the downcomer is fed to prevent the reaction gas mixture from entering the downcomer. In some embodiments, the barrier fluid is fed in the upper part of the downcomer. In some embodiments, the barrier fluid has a composition different from that of the gas mixture present in the riser unit. In some embodiments, the amount of added barrier fluid is adjusted such that an upward flow of gas countercurrent to the flow of the polymer particles is generated, acting as a barrier to the gas mixture entrained with the particles coming from the riser unit. In some embodiments, the countercurrent is at the top of the downcomer.

In some embodiments, the barrier fluid comes from a recycle gas stream, alternatively obtained by partly condensing the stream. In some embodiments, the barrier fluid contains the monomers to be polymerized, inert compounds used as a polymerization diluent, hydrogen, or other components of the reaction gas mixture. In some embodiments, the polymerization diluent is selected from the group consisting of nitrogen and alkanes having from 1 to 10 carbon atoms.

In some embodiments, the polymerization in the gas-phase polymerization reactor is carried out in a condensing or super-condensing mode, wherein part of the circulating reaction gas mixture is cooled to below the dew point and returned to the reactor separately as a liquid and a gas-phase or together as a two-phase mixture to make additional use of the enthalpy of vaporization for cooling the reaction gas.

In some embodiments, the gas-phase polymerization reactor including the riser unit and the downcomer is part of a reactor cascade. In some embodiments, the further polymerization reactors of the reactor cascade are low-pressure polymerization reactors such as gas-phase reactors or suspension reactors. In some embodiments, the polymerization process of the reactor cascade includes a polymerization in suspension, wherein the suspension polymerization is carried out upstream of the gas-phase polymerization. In some embodiments, suspension polymerization is carried out in loop reactors or stirred tank reactors. In some embodiments, the suspension media are inert hydrocarbons or the monomers. In some embodiments, the inert hydrocarbons are isobutane or mixtures of hydrocarbons. In some embodiments, the additional polymerization stages, which are carried out in suspension, include a pre-polymerization stage. In some embodiments, the multistage polymerization of olefins includes additional polymerization stages carried out in gas-phase. In some embodiments, the gas-phase polymerization reactors are selected from the group consisting of horizontally or vertically stirred gas-phase reactors, fluidized-bed reactors or multizone circulating reactors. In some embodiments, the additional gas-phase polymerization reactors are arranged downstream or upstream of the gas-phase polymerization reactor. In some embodiments, the gas-phase polymerization reactor including the riser unit and the downcomer is part of a reactor cascade wherein a fluidized-bed polymerization reactor is arranged upstream of the gas-phase polymerization reactor.

The FIGURE shows schematically a set-up of a polymerization reactor cascade including a fluidized-bed reactor and a multizone circulating reactor for preparing bimodal or multimodal polyolefins.

The first gas-phase reactor, fluidized-bed reactor (1), includes a fluidized bed (2) of polyolefin particles, a gas distribution grid (3) and a velocity reduction zone (4). In some embodiments, the velocity reduction zone (4) has an increased diameter compared to the diameter of the fluidized-bed portion of the reactor. The polyolefin bed is kept in a fluidization state by an upward flow of gas fed through the gas distribution grid (3) placed at the bottom portion of the reactor (1). The gaseous stream of the reaction gas mixture leaving the top of the velocity reduction zone (4) via recycle line (5) is compressed by compressor (6), transferred to a heat exchanger (7), wherein the gaseous stream is cooled, and then recycled to the bottom of the fluidized-bed reactor (1) at a point below the gas distribution grid (3) at position (8). In some embodiments, the recycle gas was cooled to below the dew point of one or more of the recycle gas components in the heat exchanger to operate the reactor with condensed material, that is, in the condensing mode. In some embodiments, the recycle gas was made from or contained unreacted monomers, inert condensable gases, and inert non-condensable gases. In some embodiments, the inert condensable gases were alkanes. In some embodiments, the inert non-condensable gas was nitrogen. In some embodiments, make-up monomers, hydrogen, inert gases, or process additives were fed into the reactor (1) at various positions. In some embodiments, the feeding occurred via line (9) upstream of the compressor (6). In some embodiments, the catalyst is fed into the reactor (1) via a line (10). In some embodiments, line (10) is placed in the lower part of the fluidized bed (2).

The polyolefin particles obtained in fluidized-bed reactor (1) are discontinuously discharged via line (11) and fed to a solid/gas separator (12) to avoid that the gaseous mixture coming from the fluidized-bed reactor (1) enters the second gas-phase reactor. The gas leaving solid/gas separator (12) exits the reactor via line (13) as off-gas while the separated polyolefin particles are fed via line (14) to the second gas-phase reactor.

The second gas-phase reactor is a multizone circulating reactor (21) including a riser (22) and a downcomer (23) which are repeatedly passed by the polyolefin particles. Within riser (22), the polyolefin particles flow upward under fast fluidization conditions along the direction of arrow (24). Within the downcomer (23) the polyolefin particles flow downward under the action of gravity along the direction of the arrow (25). The riser (22) and the downcomer (23) are interconnected by the interconnection bends (26) and (27).

After flowing through the riser (22), the polyolefin particles and the reaction gas mixture leave riser (22) and are conveyed to a solid/gas separation zone (28). In some embodiments, the solid/gas separation is effected by a centrifugal separator like a cyclone. From the separation zone (28), the polyolefin particles enter downcomer (23).

The reaction gas mixture leaving the separation zone (28) is recycled to the riser (22) by a recycle line (29), equipped with a compressor (30) and a heat exchanger (31). Between the compressor (30) and the heat exchanger (31), the recycle line (29) splits and the gaseous mixture is divided into two separated streams; line (32) conveys a part of the recycle gas into the interconnection bend (27) while line (33) conveys another part the recycle gas to the bottom of riser (22), thereby establishing fast fluidization conditions.

The polyolefin particles coming from the first gas-phase reactor via line (14) enter the multizone circulating reactor (21) at the interconnection bend (27) in position (34). The polyolefin particles obtained in multizone circulating reactor (21) are continuously discharged from the bottom part of downcomer (23) via the discharge line (35).

A part of the gaseous mixture leaving the separation zone (28) exits the recycle line (29) after having passed the compressor (30) and is sent through line (36) to the heat exchanger (37), where the portion of the gaseous mixture is cooled to a temperature at which the monomers and the optional inert gas are partially condensed. A separating vessel (38) is placed downstream of the heat exchanger (37). In some embodiments, the separated liquid is withdrawn from the separating vessel (38) via line (39) and fed to downcomer (23) through lines (40), (41), (42) and (43) by a pump (44), wherein the feed stream introduced via line (40) is supplied to generate the barrier for preventing the reaction gas mixture of the riser (22) from entering the downcomer (23). In some embodiments, make-up monomers, make-up comonomers, inert gases, or process additives are introduced via lines (45), (46) and (47) into lines (41), (42) and (43) and then fed into the downcomer (23) at monomer feeding points (48), (49) and (50). In some embodiments, make-up monomers, make-up comonomers, inert gases, or process additives are further introduced into the recycle line (29) via line (51). The gaseous mixture obtained as gas-phase in the separating vessel (38) is recirculated to recycle line (29) through line (52).

The bottom of the downcomer (23) is equipped with a control valve (53) having an adjustable opening for adjusting the flow of polyolefin particles from downcomer (23) through the interconnection bend (27) into the riser (22). Above the control valve (53), amounts of a recycle gas mixture coming from the recycle line (29) through line (54) are introduced into the downcomer (23) to facilitate the flow of the polyolefin particles through the control valve (53).

In some embodiments, the polymerization for preparing the bimodal or multimodal polyolefins is carried out with olefin polymerization catalysts. In some embodiments, the polymerization is carried out using Phillips catalysts based on chromium oxide, titanium-based Ziegler- or Ziegler-Natta-catalysts, single-site catalysts, or mixtures of such catalysts. In some embodiments, the polymerization catalyst is a Ziegler- or Ziegler-Natta-catalyst made from or containing the reaction product of an aluminum alkyl with a titanium compound supported on a magnesium halide.

In some embodiments, the bimodal or multimodal polyolefins have been obtained in the polymerization in form of a polyolefin powder, that is, in form of small particles. In some embodiments, the mass-median-diameter D50 of these polyolefin particles is in the range from 300 μm to 2500 μm, alternatively from 400 μm to 2500 μm, alternatively from 600 μm to 2300 μm, alternatively from 800 μm to 2100 μm, determined by dry sieving analysis according to DIN 53477 (November 1992).

In some embodiments, the polyolefins are polyethylenes having a density from 0.90 g/cm³ to 0.97 g/cm³. In some embodiments, the density is in the range of from 0.920 to 0.968 g/cm³, alternatively from 0.945 to 0.965 g/cm³. The density has to be understood as being the density determined according to DIN EN ISO 1183-1:2004, Method A (Immersion) with compression molded plaques of 2 mm thickness which were pressed at 180° C., 20 MPa for 8 minutes with subsequent crystallization in boiling water for 30 minutes.

In some embodiments, the polyolefins are polyethylenes having a melt flow rate MFR_{21.6} at 190° C. under a load of 21.6 kg, determined according to DIN EN ISO 1133:2005 condition G, from 0.5 to 300 g/10 min, alternatively from 1 to 100 g/10 min, alternatively from 1.2 to 100 g/10 min, alternatively from 1.5 to 50 g/10 min.

In some embodiments, the polyolefin compositions are prepared in an extruder device. In some embodiments, the extruder devices are extruders or continuous mixers. In some embodiments, the extruders or mixers are single- or two-stage machines which melt and homogenize the polyethylene composition. In some embodiments, the extruders are pin-type extruders, planetary extruders or corotating disk processors. In some embodiments, the extruder devices are combinations of mixers with discharge screws or gear pumps. In some embodiments, the extruders are screw extruders, alternatively extruders constructed as twin-screw machine. In some embodiments, the extruder devices are selected from the group consisting of twin-screw extruders and continuous mixers with discharge elements. In some embodiments, the extruder devices are continuous mixers with counter rotating twin rotor. In some embodiments, the extruder device includes at least one co-rotating twin screw extruder. In some embodiments, the extruder devices are commercially available from Coperion GmbH, Stuttgart, Germany; KraussMaffei Berstorff GmbH, Hannover, Germany; The Japan Steel Works LTD., Tokyo, Japan; Farrel Corporation, Ansonia, USA; or Kobe Steel, Ltd., Kobe, Japan. In some embodiments, the extruder devices are equipped with units for pelletizing the melt, such as underwater pelletizers.

In the process for preparing the polyolefin compositions, as step a), the bimodal or multimodal polyolefin is supplied in form of a polyolefin powder to a mixing device. In some embodiments, the mixing device allows dry-blending of particles. In some embodiments, the mixing device is operated continuously. In some embodiments, the mixing device is operated discontinuously.

In some embodiments, the dry-blending devices are paddle mixers having one or two horizontally orientated rotating shafts, alternatively two horizontally orientated counter-rotating shafts. The shafts are equipped with paddles of an appropriate geometry. The rotating shafts move the composition of polyolefin powder and additives horizontally along the axis of the shafts and at the same time mix the composition. In some embodiments, the paddle mixers are commercially available from Köllemann GmbH, Adenau, Germany or J. Engelsmann AG, Ludwigshafen, Germany. In some embodiments, the mixing device is a vertical batch mixer. In some embodiments, the vertical batch mixer is commercially available as a Henschel-Mixers® from Zeppelin Systems GmbH, Kassel, Germany. In some embodiments, the dry-blending devices are single screw conveyors equipped with blending elements. In some embodiments, the blending elements are amendable devices such as adjustable paddles or slotted flights to allow controlling the level of blending.

In step b), one or more additives are supplied to the mixing device. The additives are to be distributed uniformly within the multimodal polyolefin. In some embodiments, the additives are selected from the group consisting of antioxidants, melt stabilizers, light stabilizers, acid scavengers, lubricants, processing aids, antiblocking agents, slip agents, antistatics agents, antifogging agents, pigments or dyes, nucleating agents, flame retardants, and fillers. In some embodiments, several additives are added to the polyolefin compositions. In some embodiments, the multiple additives are different types of additives. In some embodiments, several representatives of a type of additives are added to a polyolefin composition. In some embodiments, the additives are commercially available and are as described in Hans Zweifel, Plastics Additives Handbook, 5th Edition, Munich, 2001.

In some embodiments, an additive supplied to the mixing device is an organic peroxide. In some embodiments, the organic peroxide is selected from the group consisting of dicumyl peroxide, di-tert-butyl peroxide, tert-butylperoxybenzoate, 2,5-dimethyl-2,5-di(tert-butylperoxy)hexane, 3,6,9-triethyl-3,6,9-trimethyl-1,2,4,5,7,8-hexoxonane, representatives of 3,6,9-trimethyl-3,6,9-tris(alkyl)-1,2,4,5,7,8-hexoxonanes in which the alkyl radical is propyl or ethyl, tert-butyl peroxyneodecanoate, tert-amyl peroxypivalate, and 1,3-bis(tert-butylperoxyisopropyl)benzene. In some embodiments, the organic peroxide is selected from the group consisting of 2,5-dimethyl-2,5-di(tert-butylperoxy)hexane, 3,6,9-triethyl-3,6,9-trimethyl-1,2,4,5,7,8-hexoxonane, and a representative of 3,6,9-trimethyl-3,6,9-tris(alkyl)-1,2,4,5,7,8-hexoxonanes wherein the alkyl radical is propyl or ethyl.

In some embodiments, the organic peroxide is employed in form of a polyolefin mixture. In some embodiments, the organic peroxide is added in pure form or as a solution in a diluent like a hydrocarbon. In some embodiments, the polyolefin mixtures have a content of the organic peroxide in the polyolefin mixture in the range from 0.5 to 25 wt. %, alternatively from 1 to 20 wt. %, alternatively from 2 to 10 wt. %.

In some embodiments, the amount of added organic peroxide corresponds to a content of initiator in the final polyethylene composition of from 1 to 200 ppm by weight, alternatively from 2 to 150 ppm by weight, alternatively from 3 to 120 ppm by weight.

Step c) provides mixing the polyolefin powder and the additives at a temperature in the range from 10° C. to 120° C. without melting the polyolefin powder. In some embodiments, the mixing of step c) is carried at a temperature in the range from 20° C. to 100° C., alternatively from 30° C. to 90° C.

The mixture of polyolefin powder and additives is then transferred in step d) from the mixing device into the extruder device. In some embodiments, the mixture of polyolefin powder and additives is transferred to a hopper of the extruder device and then introduced from the hopper into the extruder device. In some embodiments, the transfer of the mixture of polyolefin powder and additives into the extruder device occurs by gravity.

Within the extruder device, in step e), the mixture of polyolefin powder and additives is melted and homogenized to form a molten polyolefin composition. In some embodiments, the melting and homogenizing occurs by applying heat and mechanical energy to the mixture of polyolefin powder and additives. Step e) results in a homogenization of the polyolefin melt and provides a uniform distribution of the additives within the polyolefin melt.

Step f) provides pelletizing of the molten polyolefin composition made from or containing the bimodal or multimodal polyolefin and the additives. Step f) transforms the molten polyolefin composition into pellets.

### EXAMPLES

The melt flow rate MFR_{21.6} was determined according to DIN EN ISO 1133-1:2012-03 at a temperature of 190° C. under a load of 21.6 kg.

The melt flow rate MFR₅ was determined according to DIN EN ISO 1133-1:2012-03 at a temperature of 190° C. under a load of 5 kg.

The melt flow rate MFR_{2.16} was determined according to DIN EN ISO 1133-1:2012-03 at a temperature of 190° C. under a load of 2.16 kg.

The Flow Rate Ratio FRR is the ratio of MFR_{21.6}/MFR₅.

The density was determined according to DIN EN ISO 1183-1:2004, Method A (Immersion) with compression molded plaques of 2.5 mm thickness. The compression molded plaques were prepared with a defined thermal history from pelletized material: pressed using flash-mold at 180° C., 4 min in contact mode and 4 min at the same temperature with 20 MPa, with subsequent crystallization in boiling water for 30 min, cooling at room temperature for 30 min and finally tempering at 23.0+/−0.1° C. for 30 min.

The gel count was determined by preparing a cast film, analyzing the film defects with an optical scanning device and classifying and counting the film defects according to their size (circle diameter). The films were prepared by an extruder (type ME20) equipped with a chill roll and winder, model CR-9, and analyzed by an optical film surface analyzer with flash camera system, model FTA100 (components produced by OCS Optical Control Systems GmbH, Witten, Germany). The apparatus had the following characteristics

screw diameter: 20 mm;

screw length: 25 D;

compression ratio: 3:1;

screw layout 25 D: 10 D feeding, 3 D compression, 12 D metering;

die width (slit die): 150 mm;

resolution: 26 μm×26 μm;

and was operated under the following conditions

T 1 230° C.;

T 2 230° C.;

T 3 230° C.;

T 4 (adapter) 230° C.;

T 5 (die) 230° C.;

take off speed 3.0 m/min;

screw speed to be adjusted to film thickness 50 μm;

throughput 1.0 to 1.5 kg/h (target 1.15 kg/h);

air shower on—5 m³/h,

chill roll temperature 50° C.;

vab chill roll 4 N;

winding tensile force 4 N,

draw off strength 5 N;

camera threshold threshold 1: 75%-threshold 2: 65%.

For starting the measurement, extruder and take off unit were set to the specified conditions and started with a material having a reference gel level. The film inspection software was started when the extruder showed steady conditions of temperature and melt pressure. After having operated the extruder with the starting material for at least half of an hour or after the gel count having reached the reference gel level, the first sample was fed to the extruder. After having reached a stable gel level for 45 minutes, the counting process was started until the camera had inspected an area of at least 3 m² of film. The next sample was fed to the extruder, and after having reached again a stable gel count for 45 minutes, the counting process for the next sample was started. The counting process was set for the samples such that the camera inspected an area of at least 3 m² of film, and the number of measured defects per size-class was normalized to 1 m² of film.

For determining the rheological polydispersity (ER), rheological measurements were carried out in a parallel plate rotational rheometer (MCR 300, Anton Paar GmbH, Ostfildern, Germany) with 25 mm diameter plates at T=190° C. Samples were prepared in a melt-press at 200° C. under a pressure of 20 MPa for 4 min, resulting in a plate of 1 mm thickness from which 25 mm diameter discs were stamped out and inserted in the rheometer. The measurements were performed in dynamic oscillatory shear mode as a “frequency-sweep”, measuring at frequencies from 620 to 0.02 rad/s under constant strain amplitude of 5%.

ER was determined by the method of R. Shroff and H. Mavridis, “New Measures of Polydispersity from Rheological Data on Polymer Melts,” J. Applied Polymer Science 57 (1995) 1605 (see also U.S. Pat. No. 5,534,472 at Column 10, lines 20-30). Storage modulus (G′) and loss modulus (G″) were measured. The nine lowest frequency points were used (five points per frequency decade) and a linear equation was fitted by least-squares regression to log G′ versus log G″. ER was then calculated from:

ER=(1.781*10⁻³)*G′

at a value of G″=5,000 dyn/cm².

When the lowest G″ value was greater than 5,000 dyn/cm², the determination of ER involved extrapolation. The ER values calculated depended on the degree on nonlinearity in the log G′ versus log G″ plot. The temperature, plate diameter and frequency range were selected such that, within the resolution of the rheometer, the lowest G″ value was close to or less than 5,000 dyn/cm².

The determination of the particle size distribution of the produced polyethylene powder was carried out by dry sieving analysis according to DIN 53477 (November 1992) using a AS 200 control vibratory sieve shaker (Retsch GmbH, Haan, Germany) with a set of 7 calibrated sieves (125 μm, 250 μm, 500 μm, 710 μm, 1000 μm, 1400 μm, and 2000 μm). The mass-median-diameter D50 of the polyolefin particles was obtained by calculating the particle size distribution using the software Easy Sieve 4.0 of the apparatus, after weighing the fractions on each sieve.

The Dart Drop Index (DDI) was determined according to ASTM D1709, method A, on a film having thickness of 20 μm or 10 μm.

For determining the bubble stability, blown films were produced on an Alpine film blowing plant having an extruder with a diameter D₁ of 50 mm and a length of 21D₁ (=1.05 m) and an annular die having a diameter D2 of 120 mm and a gap width of 1 mm. The films were produced at increasing take-off speeds, thereby obtaining decreasing film width values. The blow-up ratio was of 4:1 and the stalk length of 90 cm. The melt temperature of the polyethylene composition in the extruder was 225-230° C.

In a preliminary test, the take-off speed was set at predetermined increasing take-off speeds, namely at 35, 58, 63, 70, 77 and 87 m/min (=maximum rolling-up speed). After the respective take-off speed had been attained and the neck length had been adjusted to 90 cm by adjusting the cooling air blower, the axial oscillation of the film bubble was observed. The test was considered finished and passed at a given speed if the axial oscillation of the bubble being formed was in the range of ±2 cm over a period of observation of one (1) minute.

The shock test was carried out at the same take-off speed setting as in the preliminary test. In the shock test, the bubble was made axially oscillate. This was performed by fully opening the iris of the cooling air blower for a period of about 7 s. The iris was then reset to the initial position. The opening and closing of the iris was monitored via the pressure of the cooling air. At room temperature greater than 25° C., however, the opening of the iris alone was insufficient to set the film bubble into oscillation. Accordingly, at temperatures greater than 25° C., the iris was firstly opened and then shut completely for a maximum of 3 s, after which the iris was reset to the initial position, always monitoring by air pressure. The shock test was considered passed at a given take-off speed if the oscillations of the film bubble had abated to ±2 cm within 2 minutes.

If the shock test or the preliminary test was not passed at a particular take-off speed, the stability grade corresponding to the previous lower take-off speed was awarded. The below ranking was used to award the stability grade.

| | |
|---|---|
| Take-off speed [m/min.] | Stability grade |

| | | |
|---|---|---|
| 87 | (8 μm) | 1 |
| 77 | (9 μm) | 2 |
| 70 | (10 μm) | 3 |
| 63 | (11 μm) | 4 |
| 58 | (12 μm) | 5 |
| 35 | (20 μm) | 6 |

### Example 1

A polyethylene was prepared in a cascade of a fluidized-bed reactor and a multizone circulating reactor (MZCR) having two interconnected reaction zones as shown in the FIGURE.

10 g/h of a Ziegler-Natta catalyst, which was prepared as described for Example 1a in Patent Cooperation Treaty Publication No. WO 2014/202420 A1 with a molar feed ratio of electron donor/Ti of 8, were fed using 5 kg/h of liquid propane to a first stirred precontacting vessel, into which additionally triisobutylaluminum (TIBA), diethylaluminum chloride (DEAC) and tetrahydrofuran (THF) were dosed. The weight ratio of triisobutylaluminum to diethylaluminum chloride was 7:1. The weight ratio of the aluminum alkyls to the catalyst solid was 5:1. The weight ratio of the aluminum alkyls to THF was 70:1. The first precontacting vessel was kept at 50° C. with a residence time of 30 minutes. The catalyst suspension of the first precontacting vessel was continuously transferred to a second stirred precontacting vessel, which was operated with a residence time of 30 minutes and kept at 50° C. The catalyst suspension was then transferred continuously to a fluidized-bed reactor (1) via line (10).

In the fluidized-bed reactor (1), ethylene was polymerized in the presence of propane as an inert diluent and using hydrogen as a molecular weight regulator. 48 kg/h of ethylene and 290 g/h of hydrogen were fed to the fluidized-bed reactor (1) via line (9). No comonomer was added. The polymerization was carried out at a temperature of 80° C. and a pressure of 2.9 MPa.

The polyethylene obtained in the fluidized-bed reactor (1) had an MFR_{2.16} of 80 g/10 min and a density of 0.967 g/cm³.

The polyethylene obtained in the fluidized-bed reactor (1) was continuously transferred to a multizone circulating reactor (21), which was operated at a pressure of 2.5 MPa and a temperature of 80° C. measured at the beginning of line (29) where the reaction gas mixture left separation zone (28). The riser (22) had an internal diameter of 200 mm and a length of 19 m. The downcomer (23) had a total length of 18 m, divided into an upper part of 5 m with an internal diameter of 300 mm, a lower part of 13 m with an internal diameter of 150 mm and in-between the upper part and the lower part a conical part having a length of 0.43 m. The final polymer was discontinuously discharged via line (35).

50 kg/h of a liquid stream were fed as barrier fluid into the upper part of the downcomer (23) via line (40). The liquid for generating the barrier originated from partially condensing recycle gas mixture in heat exchanger (37) at working conditions of 60° C. and 2.5 MPa and separating liquid and gaseous components in separating vessel (38). The gas for producing the barrier fluid had a composition of 6.5 vol. % ethylene, 0.1 vol. % hydrogen, 0.6 vol. % 1-hexene and 92.8 vol. % propane.

Additional monomers were fed to the downcomer at three monomer feeding points below the barrier. The combined quantity of fresh monomers fed into the downcomer (23) were 18 kg/h of ethylene and 0.9 kg/h of 1-hexene. Additionally, 5 kg/h of propane, 30 kg/h of ethylene and 2 g/h of hydrogen were fed through line (51) into the recycle line (29).

Of the final polyethylene powder produced in the cascade of the fluidized-bed reactor (1) and the multizone circulating reactor (21), 49% by weight were produced in the fluidized-bed reactor (1) and 51% by weight were produced in the multizone circulating reactor (21).

The final polyethylene powder has a mass-median-diameter D50 of 1549 μm.

Before being fed to the hopper of a ZSK58 twin screw extruder (Coperion GmbH, Stuttgart, Germany), the final polyethylene powder produced in the cascade of the fluidized-bed reactor (1) and the multizone circulating reactor (21) was intimately mixed with the additives Irganox 1010 (supplied by BASF SE, Ludwigshafen, Germany), Irgafos 168 (supplied by BASF SE, Ludwigshafen, Germany), calcium stearate (Ligastar CA 800, supplied by Peter Greven GmbH & Co. KG, Bad Münstereifel, Germany), and 7.5 wt. % mixture of 2,5-dimethyl-2,5-di-(tert.-butylperoxy)-hexane with polypropylene (PERGAPROP HX-7.5 PP, supplied by PERGAN GmbH, Bocholt, Germany) in a vertical batch mixer (HU 350; Zeppelin Systems GmbH, Kassel, Germany). The amounts of added additives correspond to a content of additives in the final polyethylene composition of 800 ppm by weight Irganox 1010, 800 ppm by weight Irgafos 168, 1400 ppm by weight calcium stearate, and 80 ppm by weight PERGAPROP HX-7.5 PP.

The pelletization conditions and the gel count and the rheological polydispersity (ER) of the prepared polyethylene composition are indicated in Table 1.

### Comparative Example A

Example 1 was repeated except that no peroxide was added. The amounts of added additives correspond to a content of additives in the final polyethylene composition of 800 ppm by weight Irganox 1010, 800 ppm by weight Irgafos 168, and 1400 ppm by weight calcium stearate

The pelletization conditions and the gel count and the rheological polydispersity (ER) of the prepared polyethylene composition are indicated in Table 1.

### Comparative Example B

A polyethylene composition having a content of additives in the final polyethylene composition of 800 ppm by weight Irganox 1010, 800 ppm by weight Irgafos 168, 1400 ppm by weight calcium stearate, and 80 ppm by weight PERGAPROP HX-7.5 PP was prepared from the final polyethylene powder obtained in Example 1 under the same conditions as in Example 1, except that the polyethylene powder and the additives, including the mixture of peroxide and polypropylene, were separately fed to the hopper of the ZSK58 twin screw extruder.

The pelletization conditions and the gel count and the rheological polydispersity (ER) of the prepared polyethylene composition are indicated in Table 1.

TABLE 1

| | | Comparative | Comparative |
|---|---|---|---|
| | Example 1 | Example A | Example B |
| Pelletization rate [kg/h] | 165 | 165 | 165 |
| Screw speed [rpm] | 240 | 240 | 240 |
| Throttle valve position [°] | 0 | 0 | 0 |
| Specific energy [kWh/t] | 259 | 261 | 260 |
| PE Composition | | | |
| MFR₅ [g/10 min] | 0.17 | 0.18 | 0.17 |
| FRR | 31.2 | 28.9 | 31.8 |
| Gel count >450 μm [1/m²l | 33 | 12 | 145 |
| Gel count >700 μm [1/m²l | 7 | 2 | 33 |
| ER | 3.36 | 2.82 | 3.51 |
| DDI 20 μm/10 μm [g] | 305/373 | 345/403 | 295/368 |
| Bubble stability | 1 | 3-4 | 1 |

The comparison between Example 1 and Comparative Example A shows that by adding peroxide, an intended cross-linking of polymer chains can be induced, resulting in a better bubble stability. A relatively small increase in gels cannot be avoided. However, the comparison between Example 1 and Comparative Example B shows that without premixing of the polyolefin powder and the additives, including the mixture of peroxide and polypropylene, the amount of gels in the prepared polyolefin composition significantly increases by adding small amounts of peroxide.

1. A process for preparing a polyolefin composition comprising bimodal or multimodal polyolefin in an extruder device comprising the steps of:
a) supplying a bimodal or multimodal polyolefin in form of a polyolefin powder having a mass-median-diameter D50 of the polyolefin particles in the range from 300 μm to 2500 μm to a mixing device;
b) supplying one or more additives to the mixing device;
c) mixing the polyolefin powder and the additives at a temperature in the range from 10° C. to 120° C. without melting the polyolefin powder to form a mixture;
d) transferring the mixture of polyolefin powder and additives from the mixing device into the extruder device;
e) melting and homogenizing the mixture of polyolefin powder and additives within the extruder device to form a molten polyolefin composition; and
f) pelletizing the molten polyolefin composition,
wherein one of the additives is an organic peroxide.

2. The process of claim 1, wherein the mass-median-diameter D50 of the polyolefin particles is in the range from 400 μm to 2500 μm.

3. The process of claim 1, wherein the organic peroxide is selected from the group consisting of 2,5-dimethyl-2,5-di(tert-butylperoxy)hexane, 3,6,9-triethyl-3,6,9-trimethyl-1,2,4,5,7,8-hexoxonane, and representatives of 3,6,9-trimethyl-3,6,9-tris(alkyl)-1,2,4,5,7,8-hexoxonanes wherein the alkyl radical is propyl or ethyl.

4. The process of claim 2, wherein the organic peroxide is added in form of a mixture of the organic peroxide with a polyolefin powder.

5. The process of claim 1, wherein the polymerization for preparing the bimodal or multimodal polyolefin is carried out in the presence of a polymerization catalyst which is a Ziegler- or Ziegler-Natta-catalyst comprising the reaction product of an aluminum alkyl with a titanium compound supported on a magnesium halide.

6. The process of claim 1, wherein the mixing device is a paddle mixer having one or two horizontally orientated rotating shafts.

7. The process of claim 1, wherein the polyolefin powder is transferred from the mixing device to the extruder device by gravity.

8. The process of claim 1, wherein the polyolefin powder has been prepared in one or more gas-phase polymerization reactors.

9. The process of claim 8, wherein at least one of the gas-phase polymerization reactors is a multizone circulating reactor wherein a polymerization zone is a riser, wherein growing polymer particles flow upwards under fast fluidization or transport conditions, and the other polymerization zones are sub-zones of a downcomer, wherein the growing polymer particles flow downward in a densified form, wherein the riser and the downcomer are interconnected and polymer particles leaving the riser enter the downcomer and polymer particles leaving the downcomer enter the riser, thereby establishing a circulation of polymer particles through the riser and the downcomer.

10. The process of claim 1, wherein the polyolefin powder is obtained by polymerizing one or more 1-olefins in a cascade of at least two polymerization reactors.

11. The process of claim 1, wherein the polyolefin is a polyethylene.

12. The process of claim 11, wherein the polyethylene is a high density polyethylene having a density determined according to ISO 1183 at 23° C. from 0.945 to 965 g/cm³.

13. The process of claim 1, wherein the extruder device is a continuous mixer with counter rotating twin rotors or the extruder device comprises at least one co-rotating twin screw extruder.

14. A process for preparing a polyethylene composition comprising bimodal or multimodal polyethylene in an extruder device comprising the steps of
a) supplying a bimodal or multimodal polyethylene in form of a polyethylene powder having a mass-median-diameter D50 of the polyethylene particles in the range from 300 μm to 2500 μm to a mixing device;
b) supplying one or more additives to the mixing device;
c) mixing the polyethylene powder and the additives at a temperature in the range from 10° C. to 120° C. without melting the polyethylene powder to form a mixture;
d) transferring the mixture of polyethylene powder and additives from the mixing device into the extruder device;
e) melting and homogenizing the mixture of polyethylene powder and additives within the extruder device to form a molten polyethylene composition; and
f) pelletizing the molten polyethylene composition,
wherein one of the additives is an organic peroxide.

15. The process of claim 14, wherein the polyethylene powder is obtained by copolymerizing ethylene with from 0.01 wt. % to 20 wt. % of one or more C₃-C₈-1-alkenes.

16. The process of claim 15, wherein the polyethylene powder is obtained by polymerizing the ethylene and the one or more comonomers in one or more gas-phase polymerization reactors.

17. The process of claim 16, wherein at least one of the gas-phase polymerization reactors is a multizone circulating reactor wherein a polymerization zone is a riser, wherein growing polymer particles flow upwards under fast fluidization or transport conditions, and the other polymerization zones are sub-zones of a downcomer, wherein the growing polymer particles flow downward in a densified form, wherein the riser and the downcomer are interconnected and polymer particles leaving the riser enter the downcomer and polymer particles leaving the downcomer enter the riser, thereby establishing a circulation of polymer particles through the riser and the downcomer.

18. The process of claim 17, wherein the organic peroxide is added in form of a mixture of the organic peroxide with a polyethylene powder.

19. The process of claim 17, wherein the organic peroxide is selected from the group consisting of 2,5-dimethyl-2,5-di(tert-butylperoxy)hexane, 3,6,9-triethyl-3,6,9-trimethyl-1,2,4,5,7,8-hexoxonane, and representatives of 3,6,9-trimethyl-3,6,9-tris(alkyl)-1,2,4,5,7,8-hexoxonanes in which the alkyl radical is propyl or ethyl.

20. The process of claim 17, wherein the mixing device is a paddle mixer having one or two horizontally orientated rotating shafts.
